(19) United States
(12) Patent Application Publication
(10) Pub. No.: US 2015/0226987 A1
(43) Pub. Date: Aug. 13, 2015

(54) Optical Device Using Semiconductors

(71) Applicant: KOREA ADVANCED INSTITUTE OF SCIENCE AND TECHNOLOGY, Yuseong-gu Daejeon (KR)

(72) Inventors: Hyo-Hoon Park, Gangwon-do (KR); Jong Hun Kim, Daejeon (KR); Mu Hee Cho, Daejeon (KR); Tae-Woo Lee, Daejeon (KR); Young-Tak Han, Daejeon (KR)

(73) Assignee: Korea Advanced Institute of Science and Technology, Daejeon (KR)

(21) Appl. No.: 14/430,194

(22) PCT Filed: Dec. 6, 2012
(86) PCT No.: PCT/KR2012/010506

§ 371 Date: Mar. 20, 2015

(30) Foreign Application Priority Data
Sep. 25, 2012 (KR) 10-2012-0106783

(51) Int. Cl. G02F 1/025

(52) U.S. Cl. CPC G02F 1/025; G02F 2001/0152

(57) ABSTRACT

Optical refraction and reflection control can be achieved by means of semiconductor silicon which has a p-n junction structure and a waveguide structure. According to the optical device using semiconductors of the present invention, the amplitude of light can be directly modulated using the reflection or refraction control. The optical device according to the preferred embodiment of the present invention includes: a first waveguide on which an optical signal is incident, and which is formed in the same direction as that of the incident optical signal; a second waveguide that forms a fixed angle with the first waveguide; and a reflector which is capable of selecting a path of the optical signal to the first waveguide or to the second waveguide as a refractive index is changed according to an applied voltage, and which is formed to have a fixed angle of inclination with respect to the first waveguide.

### TECHNICAL FIELD

Exemplary embodiments of the disclosure relate to an optical device using semiconductors, more particularly, to an optical device for selective transmission of lights or optical signals to a first waveguide or a second waveguide, using a reflector formed of silicon materials.

### BACKGROUND

Structures for optical modulator to modulate light signals and optical switch to switch light paths are published based on the control of light reflection with a small angle (Korean Patent No. 10-2010-0066834, hereinafter, “Cited Reference 1”). However, Cited Reference 1 only proposes basic structures of reflectors for reflection or refraction of light and did not disclose a semiconductor-based structure for a semiconductor device for transmission of light signals in semiconductor chip etc.

Prior inventions propose structures of p-n junctions and waveguides to control refractive index of silicon used most in other semiconductors (U.S. Pat. No. 7,116,853, U.S. Pat. No. 7,751,654 and U.S.P. 2011/0058765). Those prior inventions have an object to control the speed of light in a waveguide, in other words, control the phase of light wave.

### DISCLOSURE

### Technical Problem

Exemplary embodiments of the present disclosure provide an optical device using semiconductors, which can achieve control of light refraction or reflection based on the silicon semiconductor having p-n junction and waveguide structures.

Exemplary embodiments of the present disclosure also provide an optical device using a semiconductor, which may directly modulate the amplitude of light by control of reflection or refraction.

### Technical Solution

To achieve these objects and other advantages and in accordance with the purpose of the invention, as embodied and broadly described herein, an optical device includes a first waveguide in which an optical signal is incident along the same direction with the first waveguide; a second waveguide forming a preset angle from the first waveguide; and a reflector where the refractive index is varied by an applied voltage to select a path of the optical signal to the first waveguide or the second waveguide, wherein the reflector includes a first interface partially in contact with the first waveguide, with the optical signal incident therein; and a second interface partially in contact with the first waveguide, with the optical signal transmitted there through, and the reflector is a semiconductor element having a p-type or n-type impurity doped therein.

The refractive index of the reflector can be varied by applying a voltage o a region of the reflector where a p-type impurity or an n-type impurity is doped, and a p+-type impurity may be further doped near the region where the p-type impurity is doped and a n+-type impurity may be further doped near the region where and the n-type impurity is doped, to apply a voltage to the region where the p-type and n-type impurities are doped.

The reflector may include a lower clad layer formed on a silicon substrate; a waveguide layer formed on the lower clad layer; a first impurity layer formed in one end of the waveguide layer; a second impurity layer formed in the other end of the waveguide layer; an upper clad layer formed on the waveguide layer; a first electrode formed on the first impurity layer, passing through the upper clad layer; and a second electrode formed on the second impurity layer, passing through the upper clad layer, and each of the first impurity layer and the second impurity layer is a p+-type impurity layer or a n+-type impurity layer.

A vertical cross section of the waveguide layer may include a first waveguide layer having a horizontal side with a first length and a vertical side with a second length; a second waveguide layer provided on the first waveguide layer, having a horizontal side with a third length and a vertical side with a fourth length, and the first length is larger than the third length.

The optical device may further include a third impurity layer formed on the second waveguide layer, in case the same type impurity is doped in the first impurity layer and the second impurity layer; and a third electrode formed on the third impurity layer, passing through the clad layer, wherein in case the first impurity layer and the second impurity layer are the same n+-type impurity, the third impurity layer is a p+-type impurity layer, and in case the first impurity layer and the second impurity layer are the same p+-type impurity layer, the third impurity layer is a n+-type impurity layer.

### ADVANTAGEOUS EFFECTS

According to the embodiments of the present disclosure, exemplary embodiments of the present disclosure provide an optical device using semiconductors, which can achieve control of light refraction or reflection based on the silicon semiconductor having a p-n junction and a waveguide structure.

Furthermore, exemplary embodiments of the present disclosure also provide an optical device using semiconductors, which may directly modulate an amplitude of light by control of reflection or refraction.

### BRIEF DESCRIPTION OF THE DRAWINGS

FIG. 1 is a diagram illustrating a method for control of optical path in a first operation mode of a reflector 30 according to embodiments of the disclosure;

FIG. 2 is a diagram illustrating a method for control of optical path in a second operation mode of the reflector 30 according to embodiments of the disclosure;

FIGS. 3a through 3h are diagram illustrating a structure and operation of an optical device according to a first embodiment of the disclosure;

FIGS. 4a through 4h are diagrams illustrating a structure and operation of an optical device according to a second embodiment of the disclosure;

FIGS. 5a through 5h are diagrams illustrating a structure and operation of an optical device according to a third embodiment of the disclosure;

FIGS. 6a through 6h are diagrams illustrating a structure and operation of an optical device according to a fourth embodiment of the disclosure;

FIGS. 7a through 7h are diagrams illustrating a structure and operation of an optical device according to a fifth embodiment of the disclosure;

FIGS. 8a through 8c are diagrams illustrating a structure and operation of an optical device according to a sixth embodiment of the disclosure;

FIGS. 9a through 9h are diagrams illustrating a structure and operation of an optical device according to a seventh embodiment of the disclosure;

FIGS. 10a through 10f are diagrams illustrating a structure and operation of an optical device according to an eighth embodiment of the disclosure; and

FIGS. 11a and 11b are diagram illustrating a structure of a waveguide and a clad and an arrangement of electrodes which can be applied to the first through eighth embodiments of the disclosure.

### BEST MODE

To solve the disadvantages described hereinabove, an optical device using semiconductors according to exemplary embodiments of the disclosure will be described in detail.

Exemplary embodiments of the disclosed subject matter are described more fully hereinafter with reference to the accompanying drawings. The disclosed subject matter may, however, be embodied in many different forms and should not be construed as limited to the exemplary embodiments set forth herein.

The change of refractive index in silicon semiconductor may be implemented by the electro-optic Kerr effect, the nonlinear optical Kerr effect, the Franz-Keldysh effect, the plasma dispersion effect (in other words, the effect of carrier injection or depletion) and the thermo-optic effect. Among those effects, the plasma dispersion effect provided by a p-n doping and an electric field may cause relatively large change in the refractive index and a high-speed control, such that it can be used the most. When an electric field is applied to the p-n doping structure, the Franz-Keldysh effect and the electro-optic Kerr effect may be also caused. However, the plasma dispersion effect is predominantly caused and thus the effect of the disclosure will be described mainly considering the plasma dispersion effect.

Functions of the disclosure are described based on a tendency of refractive index change caused by the carrier in the silicon semiconductor. The structure and method disclosed in the specification are not limited to the silicon semiconductor and they may be applied to other semiconductor materials.

According to the plasma dispersion effect in the silicon semiconductor, when the electron or the hole is injected, a refractive index is reduced in comparison with an intrinsic state. Considering such effect of the refractive index change, the present disclosure may provide a p-n junction structure and a method for current injection for reflecting or refracting light.

An optical device according to one embodiment of the disclosure may include a first waveguide 10 aligned along the same direction with a propagation direction of an optical signal incident therein, a second waveguide 20 forming a preset angle from the first waveguide 10, and a reflector 30 arranged in the branched portion of the second waveguide 20 from the first waveguide 10, of which refractive index is varied by an applied voltage. The reflector 30 according to the embodiment is a semiconductor element having a p-type or n-type impurity-doped therein and it has a function to select a path of the optical signal to the first waveguide 10 or the second waveguide 20 through the mean to change the refractive index by applying a voltage.

Specifically, the reflector 30 has a first interface partially in contact with the first waveguide 10 to receive the optical signal, a second interface partially in contact with the first waveguide 10 to pass the optical signal. The n-type and p-type impurities are doped in the reflector 30. The voltage applied to the reflector 30 may be applied via electrodes formed on n+-type and p+-type impurities-doped regions formed adjacent to the n-type and p-type impurities-doped regions. When the concentrations of the n-type or p-type impurities are sufficiently high, the voltage applied to the reflector 30 may be applied via electrodes formed directly on the n-type and p-type regions. Here, the n+-type and p+type mentioned above have a higher doping concentration than the n-type and p-type.

The first waveguide 10 according to the embodiment of the disclosure may be a main waveguide where light straightly pass through and the second waveguide 20 may be a branch waveguide where light is deflected in with a small angle.

The small angle in the embodiments of the disclosure may mean as follows.

In case p-type or n-type impurities are doped in a silicon semiconductor, the refractive index becomes lower than the refractive index in an intrinsic state by carriers of the electron and the hole. According to the carrier effect on the refractive index, a theoretical value of the refractive index in a range of a donor concentration from 5×10¹⁷ to 1×10²⁰ may be lowered by 5×10 through 1×10⁻¹ in comparison to an intrinsic-stated silicon (the refractive index n₁ of the intrinsic silicon is approximately 3.5). In other words, a difference of the refractive index A n between the doped state (n₂) and the intrinsic state (n₁) is in a range of Δn=n₁ -n₂ from −0.0005 to −0.1 and (n₁ -n₂)/n₁ from −0.00015 to −0.03. A critical angle to induce the total internal reflection of light at the interface where the refractive index is lowered in this range is in a range of 1° to 15°. In other materials the variation of the refractive index induced by an electric field or doping is not exceeding the range mentioned above. Considering the range of the variation of the refractive index achievable by an electric field even in a generally usable material, the critical angle is smaller enough to be in a range of 20° or less. Accordingly, the reflection at the small angle means the reflection at a range of 20° or less which can substantially achieve the total reflection with the variation of the refractive index and the embodiments of the disclosure are not limited thereto.

The optical device according to the embodiment of the disclosure may vary the refractive index of the reflector 30 once a controller (not shown) applies an electric signal to the reflector 30 and it may control reflection and/or refraction of light, to control the path of an optical signal.

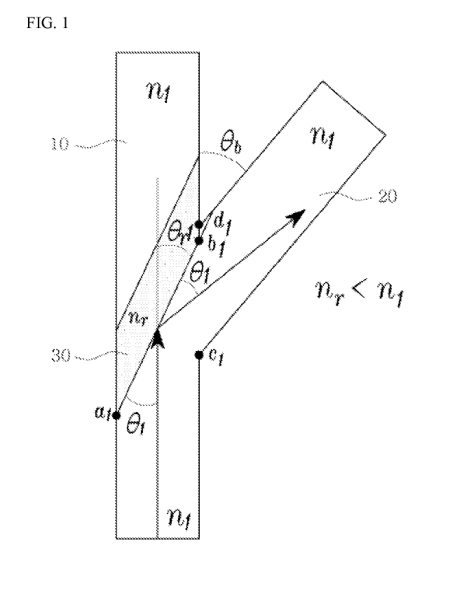

First of all, FIG. 1 is a diagram illustrating a method for control of the path of an optical signal in a first operation mode of the reflector 30.

In the first operation mode of the reflector 30 as shown in FIG. 1, a refractive index (nᵣ) of the reflector is made lower than a refractive index (n₁) of the first waveguide 10 and the second waveguide 20 (nᵣ<n₁) and light is guided to the second waveguide 20, using internal reflection of light at the first interface partially in contact with the first waveguide 10. When nᵣ is controlled to be closer to n₁ in the structure shown in FIG. 1, the light may pass to the first waveguide 10 straightly.

Specifically, the first interface of the reflector 30 (a line connected from aᵢ to b₁) is the interface where light is reflected. The reflector 30 has to be installed an inner portion of a line connected between c₁ and d₁ which is an aperture of the second waveguide 20. An angle (θ_{b}) formed by the second waveguide 20 with the first waveguide 10 is equal to or larger than an angle (θ₁) formed by the reflector 30 with the first waveguide 10 (θ_{b}≧θᵣ₁).

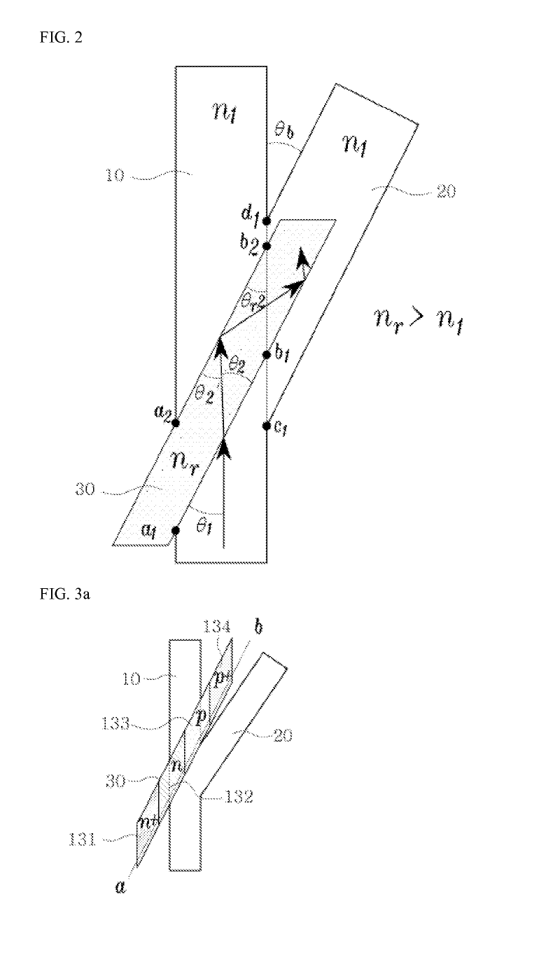

Next, FIG. 2 is a diagram illustrating a method for control of the path of an optical signal in a second operation mode of the reflector 30 according to embodiments of the disclosure.

In the second operation mode of the reflector 30 as shown in FIG. 2, a refractive index (nᵣ) of the reflector is made higher than a refractive index (n₁) of the first waveguide 10 and the second waveguide 20 (nᵣ>n₁) and external refraction of light at the first interface is generated and the light is guided to the second waveguide 20 by internal reflection generated in the second interface. When nᵣ is controlled to be closer to n₁ in the structure shown in FIG. 1, the light may pass to the first waveguide 10 straightly.

Specifically, in the structure shown in FIG. 2, the internal reflection of the light can be generated at the second interface and then the internal reflection of the light can be re-generated at the first interface, such that the light may be confined in the reflector 30. Accordingly, the light refracted at the first interface of the reflector 30 generates internal reflections in the reflector 30, to be guided into the second waveguide 20. To generate such the guide of the light in the reflector 30, the second interface (the line connected between a₂ and b₂) and the first interface (the line connected between a₁ and b₁) has to be in an inner portion of the line connected between c₁ and d₁ which is the aperture of the second waveguide 20. More specifically, b₂ is arranged near d₁ or in an inner portion of the line connected between c₁ and d₁. b₁ is arranged near c₁ or in an inner portion of the line connected between c₁ and d₁. The angle (θ_{b}) formed by the second waveguide 20 with the first waveguide 10 may be equal to or larger than the angle (θᵣ₂) formed by the reflector 30 with the first waveguide 10 (θ_{b}>θᵣ₂)

Even when the angle (θ_{b}) formed by the second waveguide 20 with the first waveguide 10 is smaller than the angle (θᵣ₂) formed by the reflector 30 with the first waveguide 10 (θ_{b}<θᵣ₂), the light internally reflected in the second interface can be internally reflected again at the first interface, guiding the light to the second waveguide 20. In other words, either of those cases that the angle (θ_{b}) formed by the second waveguide 20 with the first waveguide 10 is larger or smaller than the angle (θᵣ₂) formed by the reflector 30 with the first waveguide 10, the structure shown in FIG. 2 may guide the light, principally, to the second waveguide 20.

Hereinafter, the state where the light passes through the overall reflector 30 to travel to the first waveguide 10 as shown in FIGS. 1 and 2 is referred to as “the pass state” and the state where the light is guided to the second waveguide 20 is referred to as “the reflection state”. Proper control of the refractive index of the reflector 30 makes the pass state and the reflection state be switched to switch the optical path and also makes the amplitude of the optical signal passing one of the first and second waveguides 10 and 20 be modulated into a digital signal.

Examples of the p-n junction structure capable of achieving the function of the optical path change, using the structure shown in FIG. 1, will be shown in first to sixth embodiments. Specific examples of the p-n junction structure capable of achieving the function of the optical path change, using the structure shown in FIG. 2 will be shown in seventh and eighth embodiments.

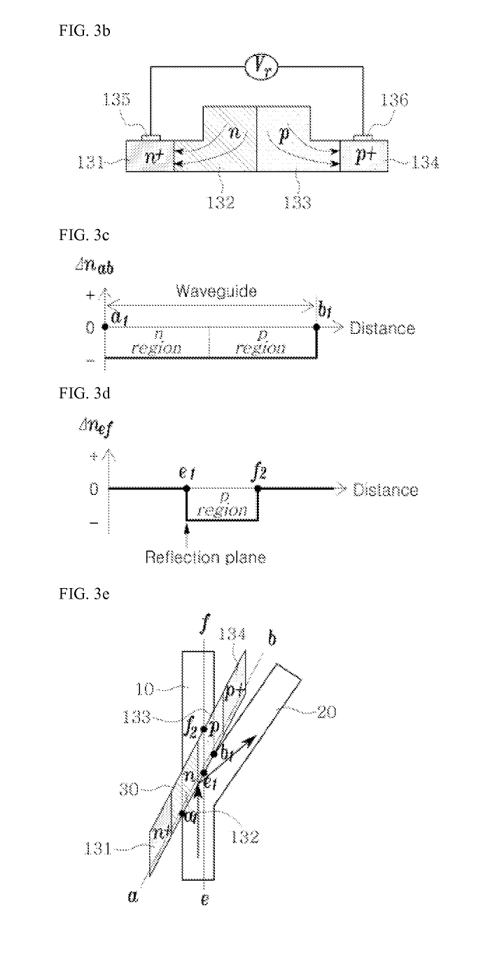

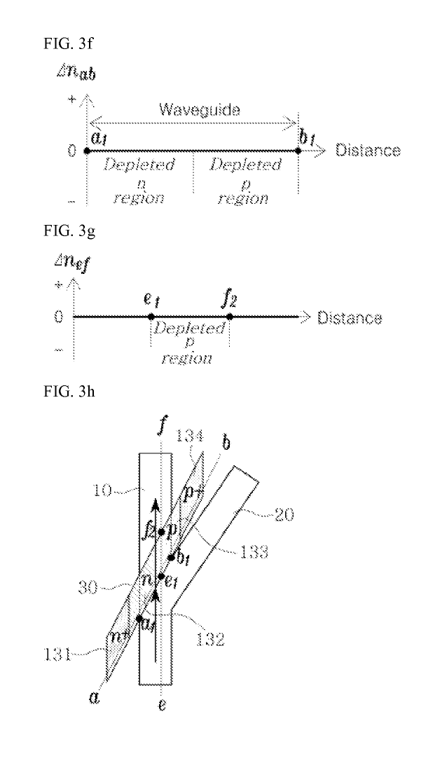

FIGS. 3a through 3h are diagram illustrating a structure and operation of an optical device according to a first embodiment of the disclosure.

Specifically, the optical device according to the first embodiment of the disclosure has the p-n junction arranged near a center of the first waveguide 10 and the p-n junction is arranged longitudinally with respect to the first waveguide 10.

FIG. 3a is a top view of the arrangement of p and n doped regions and FIG. 3b is a cross-sectional view cut along a-b line inside the first interface of the reflector 30. p+ 134 and n+ 131 regions are in contact with metallic electrodes 135 and 136 for applying an electric field. FIG. 3c shows an example of distribution of the refractive index (n_{ab}) in a traverse direction along the first interface (a₁-b₁), when an electric bias voltage (Vᵣ) is not applied to the p-n junction (Vᵣ=0). FIG. 3d shows an example of distribution of a refractive index (n_{ef}) in a longitudinal direction (e-f) along the first waveguide 10. FIG. 3e shows a function of the reflection state where the light is reflected at the first interface of the reflector 30, when a bias voltage (Vᵣ) is not applied. FIG. 3f shows an example of distribution of the refractive index in a traverse direction along the fist interface (the line of a₁-b₁), when an electric reverse bias is applied to the p-n junction. FIG. 3g shows an example of distribution of the refractive index in a longitudinal direction (e-f) of the first waveguide 10. The reverse bias means that—electric field is applied to p 133 and + electric field is applied to n 132. In the embodiment, Vᵣ<0. FIG. 3h shows a function of the pass state where the light after passing the first interface of the reflector 30 travels to the first waveguide 10 straightly, in case of Vᵣ<0.

Specifically, in the first embodiment of the disclosure, when the electric bias is not applied to the p-n junction (Vᵣ=0), a refractive index of a doped p and n regions 133 and 132 is relatively lower than neighboring regions as shown in FIG. 3c. Accordingly, the light incident in the first interface (a₁-b₁) of the reflector 30 undergoes a variation of the refractive index from a high state to a low state as shown in FIG. 3d, to cause internal reflection. When an incidence angle (θ₁) is smaller than a critical angle (θ_{c1}) of the first interface, total internal reflection may occur. In a state of Vᵣ=0, the total internal reflection may guide the light to the first waveguide 10 and the function of the reflection state may be obtained as shown in FIG. 3e. When a reverse bias (Vᵣ<0) is applied the carriers of the hole and electron are depleted in the p and n regions 133 and 132. In this state, the refractive index in the depletion region is increased to a level of the intrinsic state and a difference between the refractive indexes in the first interface of the reflector 30 becomes smaller as shown in FIG. 3g and a critical angle in the first interface is shifted to a much smaller angle. If the reverse voltage is applied to a proper level to be able to shift the critical angle (θ_{c1}) below the incidence angle (θ₁), the light is refracted through the first interface and straightly travels to the first waveguide 10, providing the function of the pass state. In the structure of the first embodiment, applying the proper reverse bias voltage, the path of the light can be changed to the first waveguide 10 from the second waveguide 20.

In brief, the reflector 30 provided in the optical device according to the first embodiment of the disclosure may include the first interface partially in contact with the first waveguide 10 to have the optical signal incident therein and the second interface partially in contact with the first waveguide 10 to have the optical signal transmitted there through, and the reflector 30 has the n-type and p-type impurities 132 and 133 doped therein. The n-type and p-type impurity-doped regions 132 and 133 are provided in the first interface and a junction area between the n-type 132 and the p-type 133 is arranged in the longitudinal direction of the first waveguide, such that the optical signal can be incident in the n-type 132 and the p-type 133 impurities-doped regions. It is preferred that the n+-type 131 and p+-type 134 impurities-doped regions are formed near the n-type region 132 and the p-type region 133, to apply a voltage.

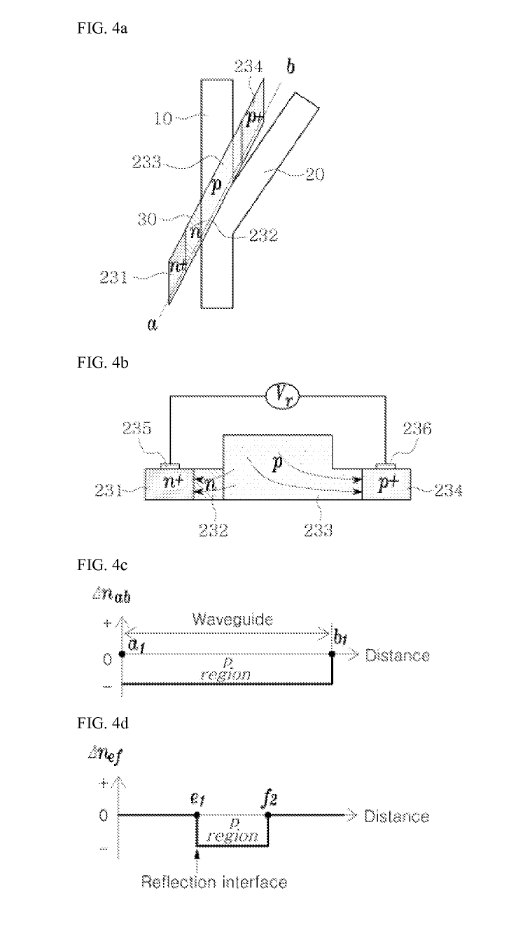

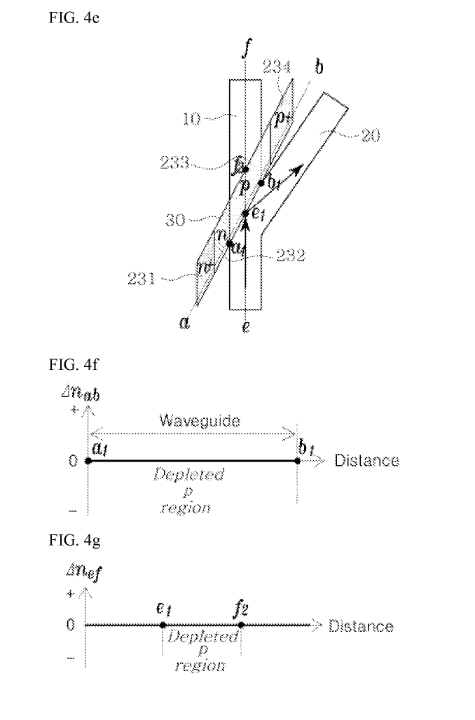

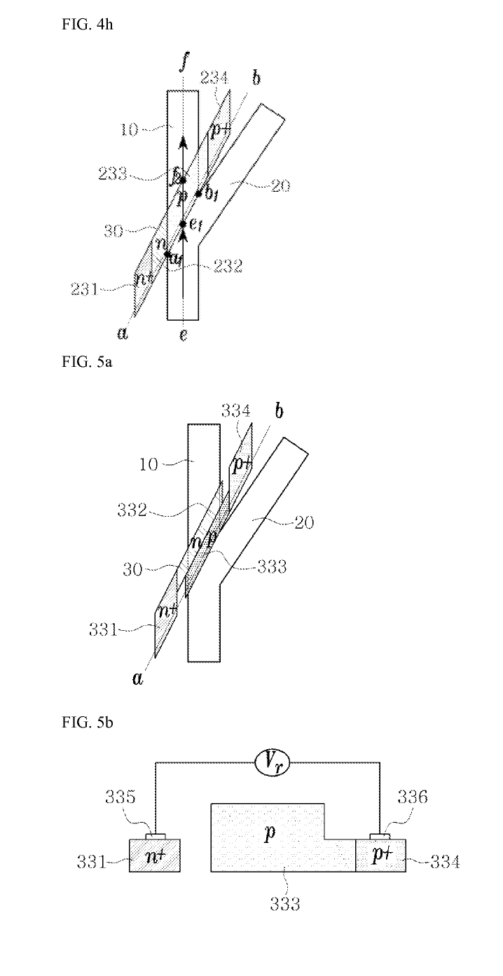

In the structure of the first embodiment of the disclosure, a thin range of a depletion region is provided in the junction between the p-type 133 and n-type 132, even when a bias is not applied. Accordingly, some of the light might be leaked through the depletion region in a state of Vᵣ=0. Also, as the applied reverse bias is getting larger, the depletion region of the junction between the p-type region 133 and the n-type region 132 is getting broadening but their depletion regions of the p-type region and the n-type region may be asymmetrically broaden. The function of the reflector 30 might be affected by the position of the junction between the p-type region and the n-type region. To overcome such disadvantages in the junction area, the p-n junction is arranged aside to an outer portion of the first waveguide 10 as shown in the second embodiment of FIG. 4.

FIGS. 4a through 4h are diagrams illustrating a structure and operation of an optical device according to a second embodiment of the disclosure.

As shown in FIGS. 4a through 4h, the optical device according to the second embodiment of the disclosure has the p-n junction arranged aside to a lateral surface of the first waveguide 10 and it is arranged in a longitudinal direction with respect to the first waveguide 10. FIGS. 4a through 4h are corresponding to the structure and function described, referring to FIGS. 3a through 3h.

In other words, the optical device according to the second embodiment of the disclosure has most of the waveguide region of the reflector 30 is arranged in a p-type region 233 for instance. Correspondingly, even in case most of the waveguide region of the reflector 30 can be arranged in an n-type region 232, a similar effect can be achieved. In the structure shown in FIGS. 4a and 4b, a refractive index of the p-type region 233 is lower than a intrinsic state nearby as shown in FIG. 4c, in case of Vᵣ=0. Accordingly, total internal reflection occurs in the first interface of the reflector 30 as indicated in FIG. 4d and a function of the reflection state for guiding the light to the second waveguide 20 can be obtained as shown in FIG. 4e. When a proper reverse bias is applied, a refractive index of a depleted p-region 233 is increased as shown in FIG. 4f and a difference between the refractive index of the p-region and that of a neighboring region is reduced as shown in FIG. 4g, such that the function of the pass state where the light passes to the first waveguide 10 can be obtained as shown in FIG. 4h.

In brief, in the optical device according to the second embodiment of the disclosure shown in FIGS. 4a through 4h, all or most of the waveguide region in the reflector is arranged by one-type impurity-doped region of the n-type or p-type impurity-doped region 232 or 233 near a lateral surface of the first waveguide and the optical signal is incident in one of the n-type and p-type impurity-doped regions with an application of a voltage.

In the structure of the optical device according to the second embodiment of the disclosure, the range of the depletion region when the reverse bias is applied is expanded from one lateral surface of the waveguide region of the reflector 30 and the width of the waveguide region of the reflector 30 could be relatively small. An example of the structure for overcoming such a disadvantage of the first embodiment is shown in a third embodiment of the disclosure.

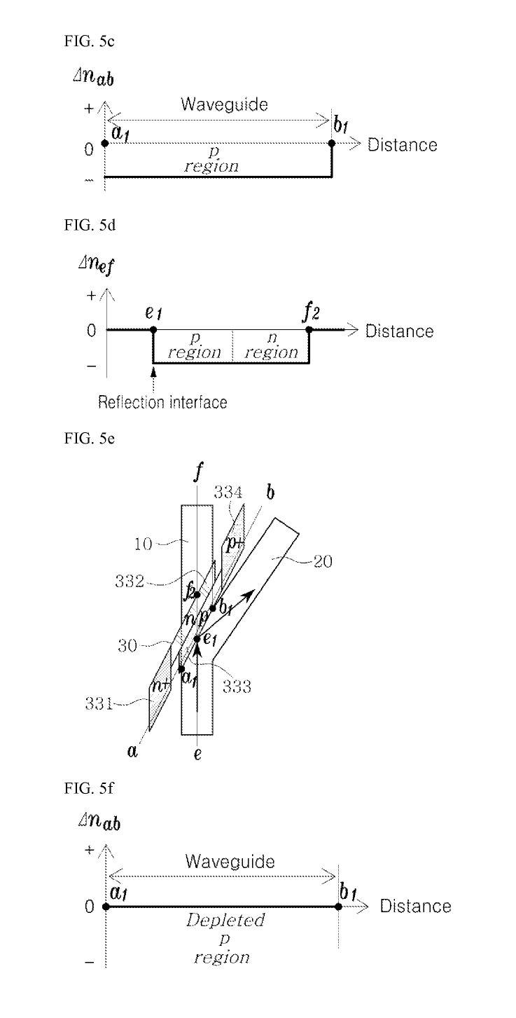

FIGS. 5a through 5h are diagrams illustrating a structure and operation of an optical device according to a third embodiment of the disclosure.

As shown in FIGS. 5a through 5h, the optical device according to the third embodiment of the disclosure has a structure in which the p-n junction is arranged in parallel to a first interface of a reflector 30 inclined a small angle (in a direction going wide a small angle of the first waveguide 10). FIGS. 5a through 5h are corresponding to the structure and function described in FIG. 3a through 3h.

The optical device according to the third embodiment of the disclosure has an advantage that a distance where carriers are moving for depletion (or a vertical direction distance with respect to the p-n junction) could be shorten, compared with the first and second embodiments. FIG. 5a shows a p-region 333 is arranged to a first interface of the reflector 30, for instance. Correspondingly, in case an n-region 332 may be arranged to the first interface of the reflector 30, a similar effect can be obtained. In the structure shown in FIG. 5b, a refractive index of the p- region 333 is lower than an intrinsic state nearby as shown in FIG. 5c, in case of Vᵣ=0. Accordingly, total internal reflection occurs at a first interface of the reflector 30 as indicated in FIG. 5d and a function of the reflection state for guiding the light to the second waveguide 20 can be obtained as shown in FIG. 5e. When a reverse bias is applied, a depletion region is expanded toward both interfaces of the reflector 30. Once a proper reverse bias is applied, a refractive index of a depleted n-region 332 and p-region 333 is increased as shown in FIG. 5f. Once the depletion region is expanded closer to the both interfaces of the reflector 30, a difference of a refractive indexes may be reduced as shown in FIG. 5g and the function of the pass state where the light passes the first waveguide 10 can be obtained as shown in FIG. 5h.

In brief, in the optical device according to the fifth embodiment of the disclosure shown in FIGS. 5a through 5h, a p-type impurity-doped region 333 is provided in one of the first and second interfaces and an n-type impurity-doped region 332 is provided in the other one. Also, all or some portion of the p-type or n-type impurity-doped region of the first interface is arranged in contact with the first waveguide 10 to have the optical signal incident therein.

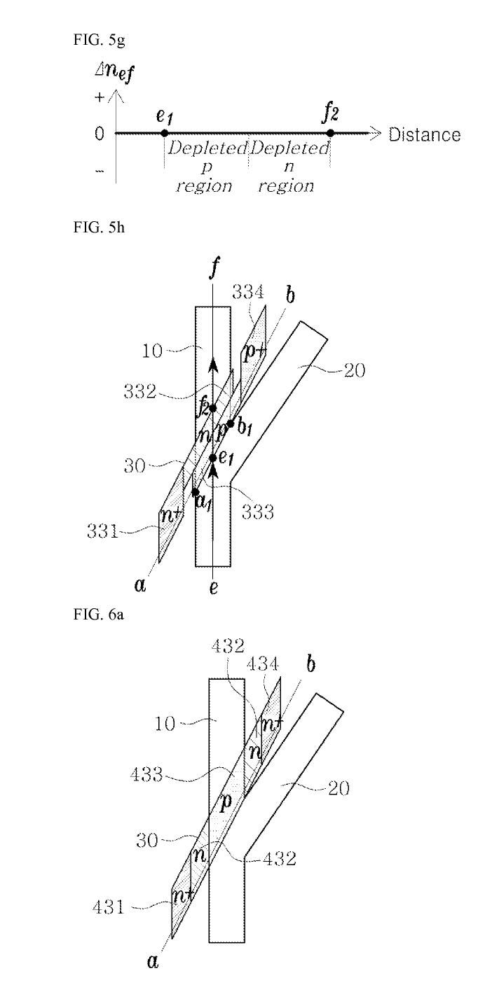

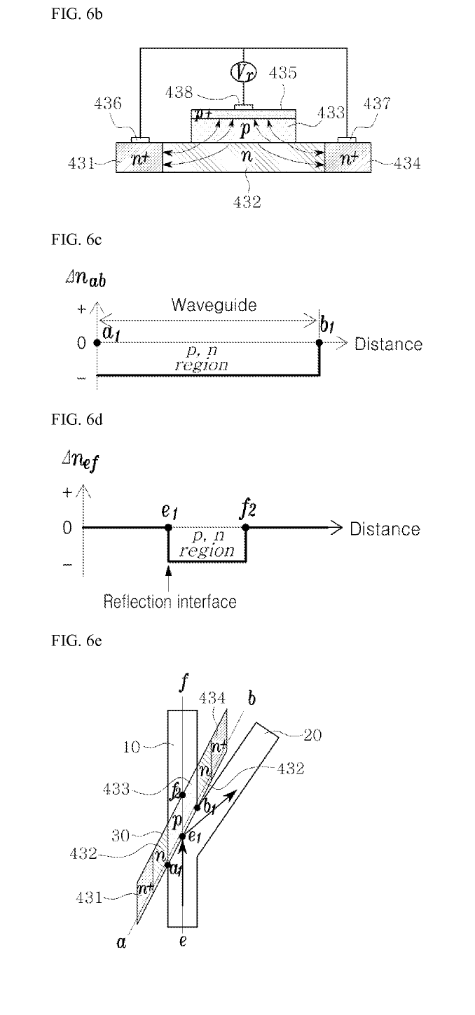

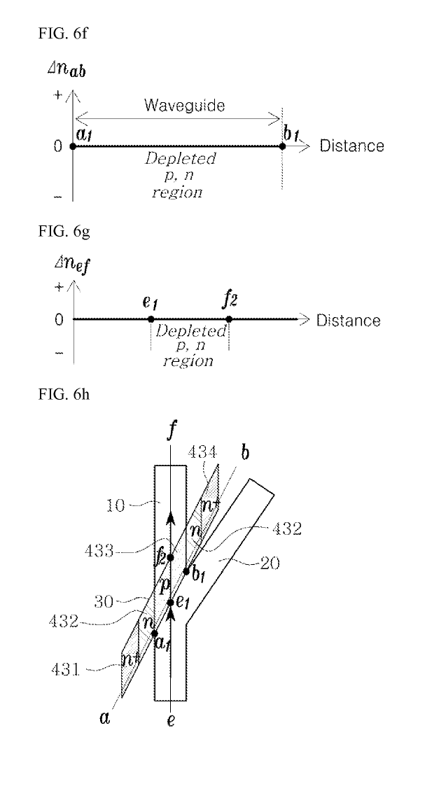

FIGS. 6a through 6h are diagrams illustrating a structure and operation of an optical device according to a fourth embodiment of the disclosure.

As shown in FIG. 6a through 6h, the optical device according to the third embodiment of the disclosure has the p-n junction arranged in a vertical direction from a cross section of the first waveguide 10. FIGS. 6a through 6h are corresponding to the structure and function described as shown in FIGS. 3a through 3h.

Specifically, FIGS. 6a and 6b show that, for instance, a p-region 433 is arranged in the upper waveguide region of the reflector 30 and an n-region 432 is arranged in the lower waveguide region of the reflector 30. Correspondingly, even in case the n-region may be arranged in the upper waveguide region of the reflector 30 and the p-region 433 is arranged in the lower waveguide region of the reflector 30, a similar effect can be obtained. In the structure shown in FIG. 6b, in a state of Vᵣ=0 a refractive index of a p-type upper waveguide 433 and an n-type lower waveguide region 432 is lower than an intrinsic state nearby as shown in FIG. 6c and total internal reflection occurs at the first interface of the reflector 30 as shown in FIG. 6d, to guide light to the second waveguide 20 as shown in FIG. 6e. Once a proper reverse bias is applied, the refractive index of the p-region 433 and the n-region 432 is increased as shown in FIG. 6f and a refractive index difference with neighboring regions is reduced as shown in FIG. 6g such that the light can pass through the first waveguide 10 as shown in FIG. 6h.

In brief, in the optical device according to the fourth embodiment of the disclosure, an n-type or p-type impurity-doped region 432 or 433 is arranged in the upper region of the first interface and a p-type or n-type impurity-doped region is arranged in the lower region of the first interface.

In the optical device according to the fourth embodiment of the disclosure, n+-type impurity-doped regions 431 and 434 are in contact with both ends of an n-type region 432 and a p+-type impurity-doped region 435 is in contact on the p-type region 433, in case an n-type region 432 is arranged in the lower region of the first interface. In this instance, most light is incident via the p-type impurity-doped region 433.

In the optical device according to the fourth embodiment of the disclosure, in case a p-type is arranged under the first interface, a p+-type impurity-doped region is in contact with both ends of the p-type region and n+-type impurity-doped region is in contact on the n-type. In this instance, most light may be incident via the n-type impurity-doped region.

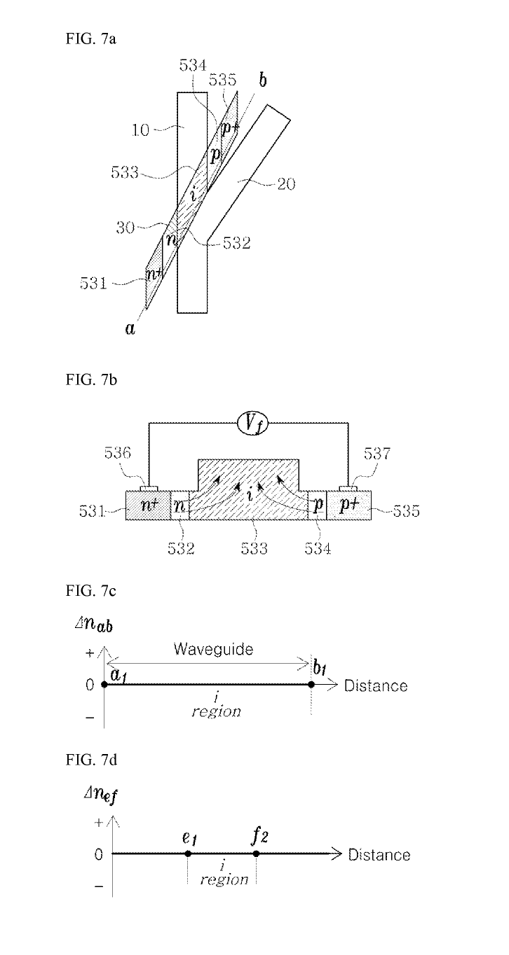

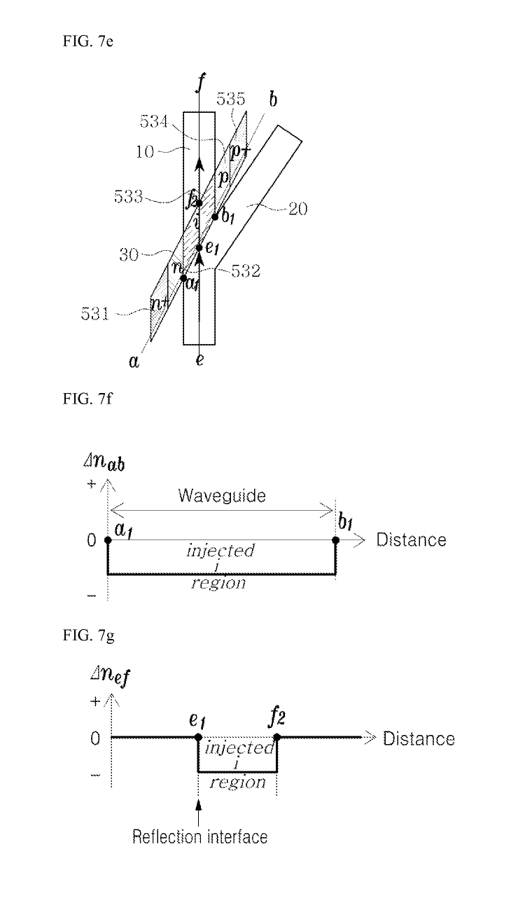

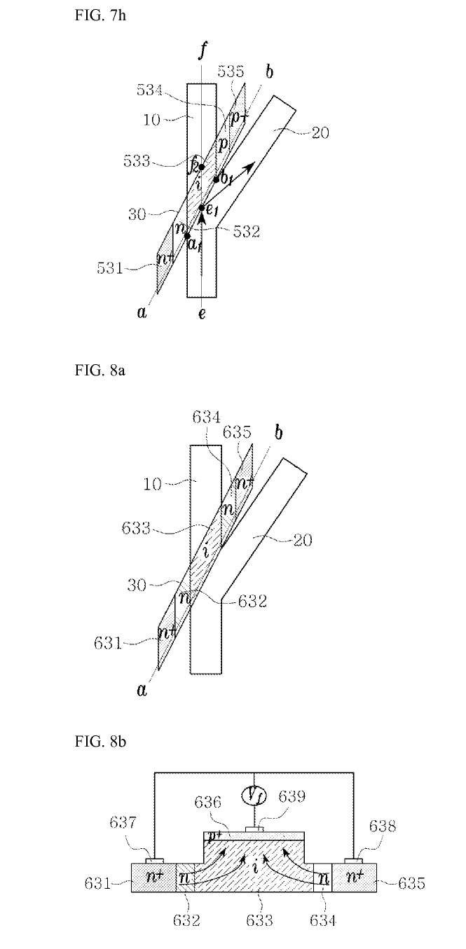

FIGS. 7a through 7h are diagrams illustrating a structure and operation of an optical device according to a fifth embodiment of the disclosure.

As shown in FIGS. 7a through 7h, the optical device according to the fifth embodiment of the disclosure has a structure using p-i-n junction in which an i (intrinsic) region is arranged in a first waveguide 10 and a p-region 534 and an n-region 532 are arranged near both lateral surfaces of the first waveguide 10 and carriers are injected into the i (intrinsic) region in a horizontal direction of a cross section of the waveguide, using a forward bias (V_{f}>0), such that a refractive index of the reflector 30 can be varied. FIGS. 7a through 7h are corresponding to the structure and function of FIGS. 3a through 3h mentioned above.

Specifically, the optical device according to the fifth embodiment of the disclosure has an intrinsic region 533 installed in a first waveguide 10 shown in FIGS. 7a and 7b as an example of the structure using p-i-n junction. A p-region 534 and an n-region 532 are arranged near both sides of the first waveguide 10. In the structure shown in FIG. 7b, an inner region of the reflector is intrinsic as shown in FIGS. 7c and 7d even in a state of V_{f}=0 and there is little difference between a refractive index of the inner region of the reflector and a refractive index of the neighboring intrinsic state of the waveguide as shown in FIGS. 7c and 7d. The light may pass the first interface of the reflector 30 and travels straightly as shown in FIG. 7e. Once a proper forward bias voltage is applied as shown in FIG. 7b, the carriers of the electron and the hole are injected in the intrinsic region 533 of the reflector 30 and the refractive index of the region where the carriers are injected becomes lowered as shown in FIG. 7f and a difference of −n (negative change of refractive index) occurs in the first interface of the reflector 30 as shown in FIG. 7g such that the light can travel to the first waveguide 10 by internal reflection as shown in FIG. 7h.

In brief, the optical device according to the fifth includes the intrinsic region 533 arranged between the n-type impurity-doped region 532 and the p-type impurity-doped region 534. The optical signal is incident in the intrinsic region 533.

In the optical device according to the fifth embodiment of the disclosure, carrier injection is accomplished in a traverse direction when the forward bias is applied. Even in case the width of the waveguide region of the reflector 30 is broad, the injection time is increased and the operation speed of the device might be lowered disadvantageously. An example of the structure for overcoming such disadvantage is shown as a sixth embodiment of the disclosure.

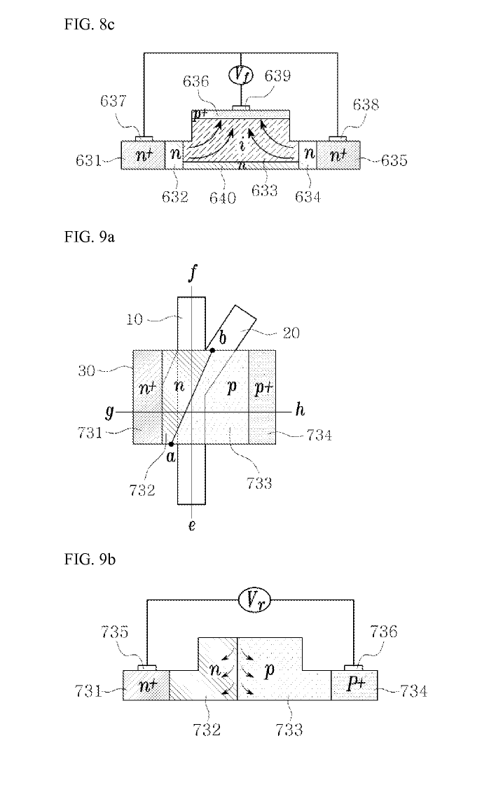

FIGS. 8a through 8c are diagrams illustrating a structure and operation of an optical device according to a sixth embodiment of the disclosure.

A shown in FIGS. 8a through 8c, carriers are injected in a vertical direction of a cross section of the waveguide as another example using a p-i-n junction. An intrinsic region 633 is installed in a waveguide and n-regions 632 and 634 are arranged near both lateral sides of a waveguide region of a reflector 30. A p+ region 636 is arranged on the intrinsic region 633 and carriers are injected upwardly from both ends of the waveguide region of the reflector (in a vertical direction of a cross section of the first waveguide 10). As another example of vertical arrangement, an n-region 640 is arranged under the intrinsic region 633 and the carrier may be injected vertically as shown in FIG. 8c. In other words, a p+ region 636 is arranged on the upper waveguide region of the reflector and n-regions 632, 634 and 640 are arranged near lateral sides or under the lower waveguide region of the reflector 30 as shown in FIGS. 8b and 8c. Correspondingly, even in case the n+ region may be arranged on the upper waveguide region of the reflector and the p-regions may be arranged near lateral sides or under the lower waveguide region of the reflector 30, a similar effect can be obtained.

In brief, in a first structure of the optical device according to the sixth embodiment of the disclosure, a first n-type impurity-doped region 632 and a first n-type impurity-doped region 634 are sequentially arranged. An intrinsic region 633 is provided between the first n-type impurity-doped region 632 and the second n-type impurity-doped region 634. Also, a p+ type impurity-doped region 636 is arranged on the upper intrinsic region 633 and the optical signal is incident in the intrinsic region 633.

Moreover, a third n-type impurity-doped region 640 may be additionally arranged between the first n-type impurity-doped region 632 and the second n-type impurity-doped region 634, under the lower intrinsic region.

In a second structure (not shown) of the optical device according to the sixth embodiment of the disclosure, a first p-type impurity-doped region and a first p-type impurity-doped region are sequentially arranged. An intrinsic region is provided between the first p-type impurity-doped region and the second p-type impurity-doped region. Also, an n+-type impurities-doped region is arranged on the upper intrinsic region and the optical signal is incident in the intrinsic region. Moreover, a third p-type impurity-doped region may be additionally arranged between the first p-type impurity-doped region and the second p-type impurity-doped region, under the lower intrinsic region.

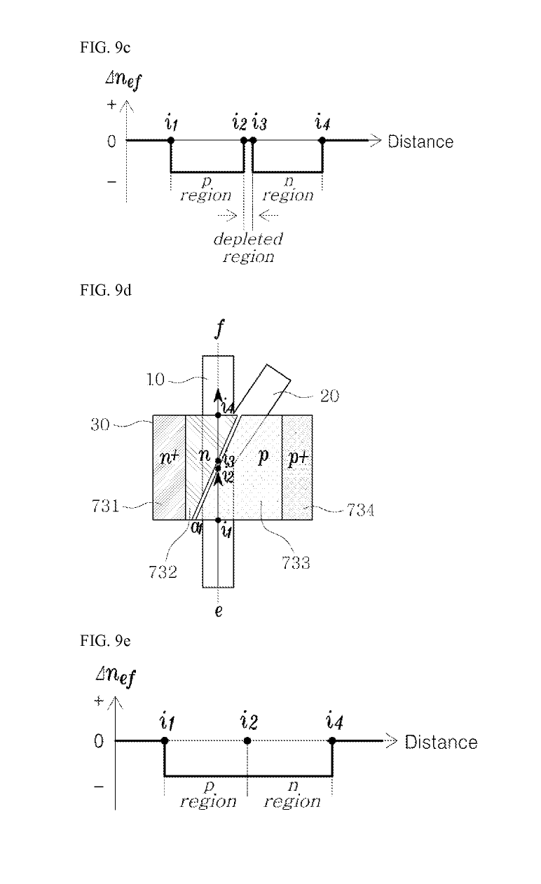

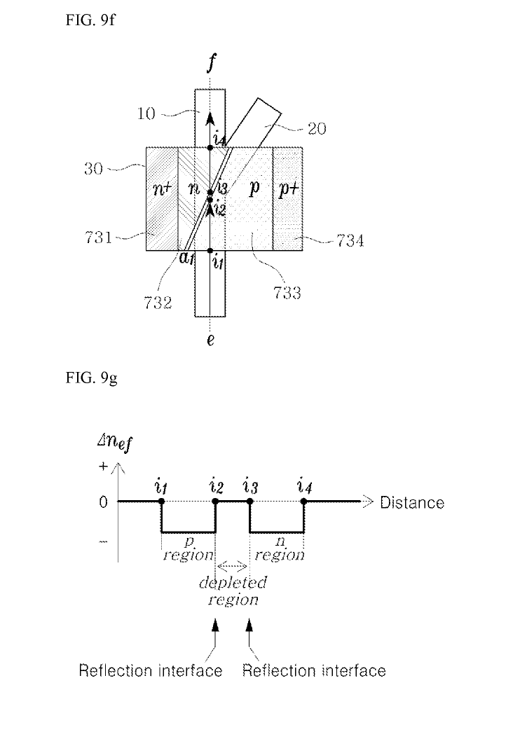

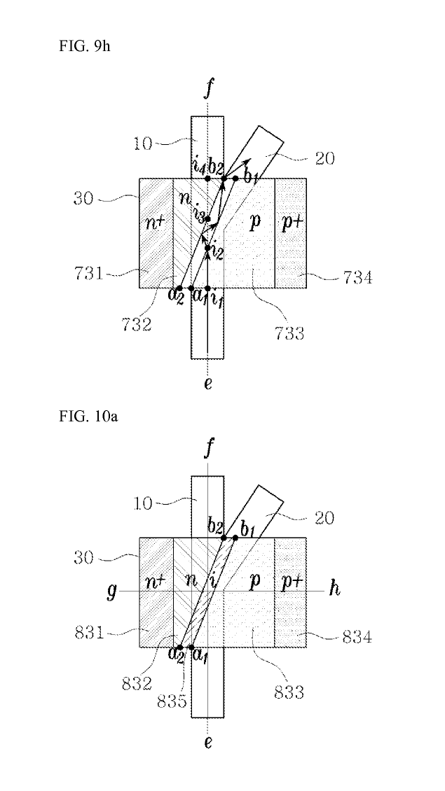

FIGS. 9a through 9h are diagrams illustrating a structure and operation of an optical device according to a seventh embodiment of the disclosure.

As shown in FIGS. 9a through 9h, the optical device according to the seventh embodiment of the disclosure has a structure for attaining a function of the reflector 30 shown in FIG. 2 using refraction and reflection, with a p-n junction. FIG. 9a is a top view illustrating arrangement of p 733 and n 732 doped regions. FIG. 9b is a sectional diagram cut away along a line g-h. FIG. 9c illustrates an example of refractive index distribution along a longitudinal direction (e-f) of a first waveguide 30, in case an electric bias is not applied to the p-n junction in case of Vᵣ=0. FIG. 9d shows a function of the pass state where light passing through a first interface of the reflector 30 travels to the first waveguide 10 in case of Vᵣ=0. FIGS. 9e and 9f show a function for enhancing straightforward propagation of light by removing a depletion region naturally formed in the junction, once a small voltage forward bias (V_{f}<0) is applied to the p-n junction. FIG. 9f shows a function of the pass state where light straightly travels at a small voltage forward bias. FIG. 9g shows an example of a refractive index distribution in a longitudinal direction (e-f) of the first waveguide 10, once an electric reverse bias is applied to the p-n junction (Vᵣ<0). FIG. 9h shows a function of the reflection state where the light is reflected in the reflector 30 to guide the light to the second waveguide 20, in case of Vᵣ<0.

More specifically, the structure and operation of the optical device according to the seventh embodiment of the disclosure shown in FIGS. 9a through 9h will be described.

In the structure of the first through sixth embodiments of the disclosure mentioned above, a p-region or n-region is arranged in a parallelogram shape along a shape of the reflector 30. Reflection of light occurs at the first interface of the p-type or n-type region. In contrast, the structure of the optical device according to the seventh embodiment of the disclosure is approximately trapezoid-shaped. Light passes through parallel sides (almost vertical with respect to the first waveguide 10) in the trapezoid shaped region and a depletion region is formed in a junction between p-type region 733 and n-type region 732 having inclined sides and total reflection is generated in the inclined depletion region, only to guide the light to the second waveguide 20. In the structure shown in FIG. 9a, the p-region 733 is arranged in an area where light is incident and an n-region 732 is arranged behind the p-region 733. Correspondingly, in case the n-region 732 is arranged in an area where light is incident and the p-region 733 is arranged behind the n-region, a similar effect can be obtained. As one example of the structure of FIG. 9a, an aperture of the p-region 733 where the light is incident is almost perpendicular to the first waveguide 10 and the light suffers a difference of the refractive index in the interface (i₁). In case there is a small difference between the refractive indexes, the light can transmit almost without reflection. In the real silicon material, the refractive index variation caused by the doping is very small and the reflection generated in the interface (i₁) can be ignored. A rear interface of the n-region behind the exit aperture of the p-region 733 is almost perpendicular to the waveguide and the light may transmit almost without reflection at this rear interface (i₄). In other words, the outer interfaces where i₁ and i₄ are located may almost not affect the propagation of the light.

When a bias is not applied in the structure shown in FIGS. 9a and 9b, a refractive index along a direction of the first waveguide 10 (a line between e-f) is distributed as shown in FIG. 9c. A thin depletion region is naturally formed by re-distribution of carriers near the p-n junction and a refractive index of the depletion region is higher than a refractive index of a neighboring doped region. The depletion region naturally formed near the p-n junction is getting thinner as a doping concentration is getting higher. When p and n doping concentrations are high enough, this natural depletion region is quite thin and the light may pass through the depletion region, without being affected by the depletion region a lot as shown in FIG. 9d. To attain the pass state of the light more definitely, a small voltage forward bias for passing light may be applied as shown in FIG. 9e. Once the forward bias is applied, the depletion region is eliminated (or reduced) near the p-n junction and the light can pass almost with little refractive index difference at the junction.

FIG. 9g shows a method for attaining a reflection state by applying a reverse bias. Once the reverse bias is applied, the depletion region is expanded near the p-n junction as shown in FIG. 9g. A refractive index of the expanded depletion region is higher than the neighboring doped region. The refractive index at the first interface of the expanded depletion region (the interface where a dot i₂ is placed) is varied to a high value, most of light suffers an external refraction and can enter into the depletion region. At the second interface (the interface where a dot i₃ is placed) of the depletion region, the refractive index is varied to a lower value again. When their variations of the refractive index are sufficiently large, the light entered into the depletion region can take place the total internal reflection at the second interface of the depletion region. This totally reflected light can take place again at the first interface of the depletion region and thus the light confined in the expanded depletion region may be guided to the second waveguide 20 shown in FIG. 9h

In brief, in the optical device according to the seventh embodiment of the disclosure, a line in contact with an n-type 732 and a p-type 733 is formed with a diagonal shape on a plane of the reflector 30. A first interface and a second interface are formed in a junction region of this diagonal line and the optical signal is guided between the first interface and the second interface, to be guided out to the second waveguide. In the optical device according to the seventh embodiment, the outer interfaces of an area where an n-type 732 and a p-type 733 are doped in the reflector may form a right angle with the first waveguide 10 or an inclined angle near the right angle and may not affect traveling of the optical signal.

Moreover, the optical signal is incident from the p-type-impurity-doped region 733 forming the first interface and guided out to the first waveguide 10, passing the n-type-impurity-doped region 732 forming the second interface Or it may be guided out to the second waveguide 20, using a depletion layer generated in a junction region between the n-type impurity-doped region 732 and the p-type impurity-doped region 733a.

Alternatively, the optical signal may be incident from the n-type-impurity-doped region 732 forming the first interface, using the p-type-impurity-doped region 733 forming the second interface.

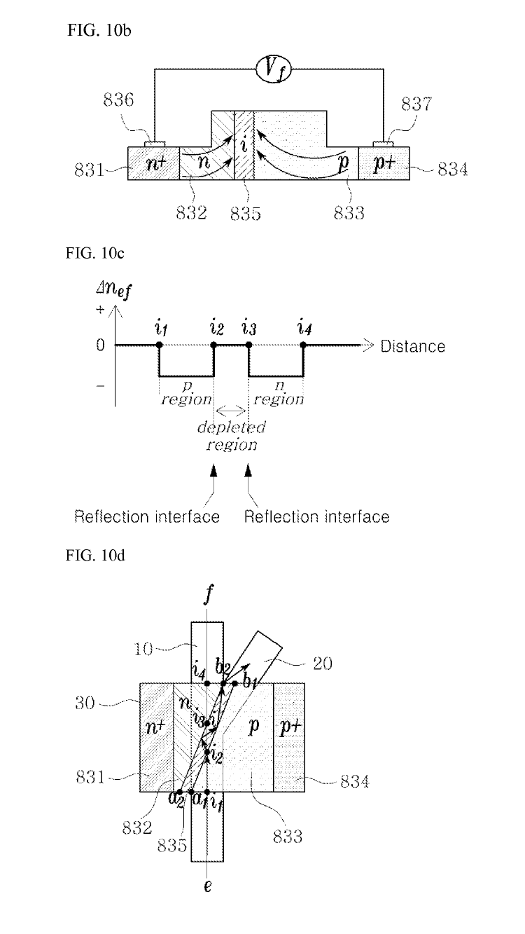

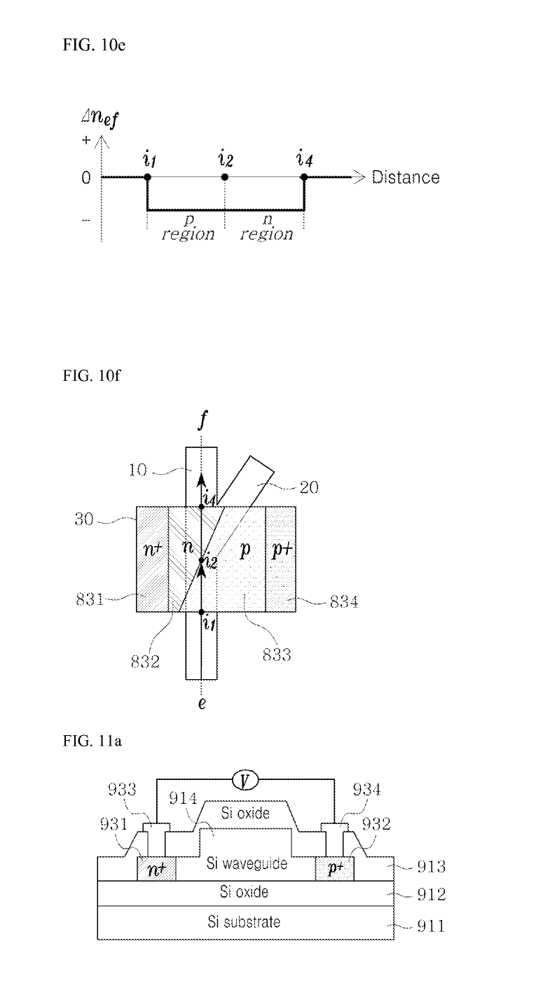

FIGS. 10a through 10f are diagrams illustrating a structure and operation of an optical device according to an eighth embodiment of the disclosure.

FIG. 10a is a top view illustrating arrangement of p 833 and n 832 doped regions. FIG. 10b is a sectional diagram cut away along a line g-h. The optical device according to the eighth embodiment of the disclosure has a structure for attaining a function of the reflector 30 shown in FIG. 2 using refraction and reflection via p-i-n junction. Forming the p-i-n junction and a reflection state as explained in FIGS. 9g and 9h can be attained even in a state where a bias voltage is not applied. In other words, an intrinsic region 835 has a higher refractive index than neighboring p-region 833 or n-region 832.

Even in a state where no bias is applied, at the first interface (the interface where a dot i₂ is placed) of the reflector 30 the refractive index is varied to a higher value as shown in FIG. 10c and most of light cannot travel into the intrinsic region 835 by external refraction. At the second interface (the interface where a dot i₃ is placed) of the intrinsic region 835 the refractive index is varied to a lower value again. When their variations of the refractive index are sufficiently large, the light in the intrinsic region 835 can take place total internal reflection at the second interface. This totally reflected light can take place again total internal reflection at the first interface of the intrinsic region 835 and then the light entered into the intrinsic region 835 may be guided out to the second waveguide 20.

Once the forward bias is applied in the structure shown in FIG. 10a, carriers are injected in the intrinsic region 835 to lower a refractive index. When a sufficient forward bias is applied, the refractive index of the intrinsic region 835 becomes lowered to be similar to the refractive indexes of n-region 832 and a p-region 833 as indicated in FIG. 10e, such that the light may pass through the first waveguide 10 as shown in FIG. 10f.

In brief, in the optical device according to the eighth embodiment of the disclosure, a reflector 30 includes an intrinsic region 835 having both diagonal-shaped sides between n-type 832 and p-type 833 regions, seen on the plane view. A first interface and a second interface are formed in both diagonal-shaped sides in the intrinsic region 835. The optical signal is incident from the n-type or p-type-impurity-doped region 832 or 833 forming the first interface and is guided out to the first waveguide 10, or to the second waveguide 20, using the intrinsic region 835 forming the second interface.

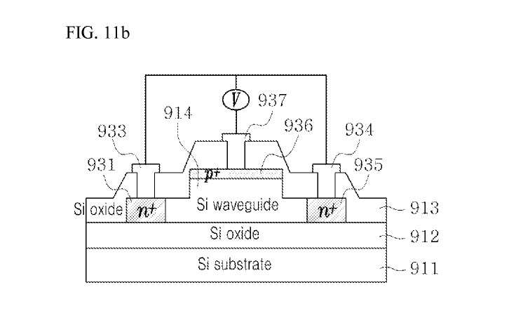

FIGS. 11a and 11b are diagram illustrating structures of a waveguides and dads and configurations of electrodes which can be applied to the first through eighth embodiments of the disclosure.

FIG. 11a is a diagram illustrating that a p+ layer 932 and an n+ layer 931 and electrodes 933 and 934 are laterally configured in both lateral ends of the waveguide. A silicon oxide layer 912 is formed on a silicon substrate 911 and a silicon rib waveguide 936 is formed on the silicon oxide layer. An upper silicon oxide layer 913 is covered on the rib waveguide 914. A lower silicon oxide layer 912 and the upper silicon oxide layer 913 are used as a clad layer of the waveguide. The p, n or i region with a p-n junction or p-i-n junction may be formed in the reflector 30 of the rib waveguide 914. According to a main feature shown in FIG. 11a, a p+ electrode 932 and an n+ electrode 931 are configured in both ends of the rib waveguide 914. Those electrodes 931 and the 932 are formed to apply a bias voltage to the p- and n-region. The p+ region 932 and the n+ region 931 arranged in both ends of the waveguide are embedded in the silicon oxide clad layer, such that metallic electrodes 933 and 934 may electrically contact with the n+ region 931 and the p+ region 932.

In FIG. 11b, one type of electrodes 931 and 935 of p+ or n+ electrodes are arranged in both ends of the waveguide. The other type of the p+ and n+ electrodes are arranged on the top of the waveguide. A thin p+ 936 or n+ region is formed on the top of the waveguide, for electrical contact with a metallic electrode 937 via the upper silicon oxide layer 913. Electrodes 933 and 934 of the both ends of the waveguide are connected as the same electrodes and a bias voltage is applied between the electrodes 933 and 934 and the electrode 937 on the waveguide.

In FIGS. 11a and 11b, the silicon oxide covering a core of the silicon waveguide has a lower refractive index than the silicon waveguide and it is employed as a clad layer of the waveguide. Instead of the silicon oxide, an insulator having a lower refractive index (e.g., silicon nitride) may be used as silicon waveguide. Alternatively, silicon crystal, poly-silicon, amorphous silicon or other types of semiconductor material may be used as silicon waveguide.

The electric connection between the p+ electrode 934 in FIG. 11a and 937 in FIG. 11b and the n+ electrode 933 in FIG. 11a and 933, 934 in FIG. 11b may be enabled by electrical interconnects used in conventional semiconductor chips. In FIGS. 11a and 11b, interconnects are simply drawn as solid lines.

The structure shown in FIG. 11a is applied to the first, second, third, fifth, seventh and eighth embodiments of the disclosure in which electrodes are laterally connected to both ends of the waveguide. The structure shown in FIG. 11b is applied to the fourth and sixth embodiments of the disclosure in which an electrode is formed on the top of the silicon waveguide and its electrode is vertically connected to the electrodes formed in both ends of the waveguide.

In brief, the reflector 30 according to the present disclosure may include a waveguide layer 914 crossing a cross section of a first waveguide 10, to pass an incident optical signal there through, a first impurity layer formed in one end of the waveguide layer 914, a second impurity layer formed in the other end of the waveguide layer 914, a first electrode 933 formed on the first impurity layer, passing through an upper clad layer 913 formed on the waveguide layer 914, and a second electrode 934 formed on the second impurity layer, passing through the upper clad layer 913. The first impurity layer and the second impurity layer are the p+-type impurity layer or n+-type impurity layer, respectively.

The optical device according to the disclosure may further include a silicon substrate 911, a lower clad layer 912 formed on the silicon substrate 911, a waveguide layer 914 formed on the lower clad layer 912 and an upper clad layer 913 formed on the waveguide layer 914.

A longitudinal cross section of the waveguide layer 914 includes a first waveguide layer having a horizontal side with a first length and a vertical side with a second length, and a second waveguide layer arranged in a central portion above the first waveguide layer, having a horizontal side with a third length and a vertical side with a fourth length. Specifically, the first length is longer than the third length and the waveguide layer 914 forms the rib waveguide.

The reflector 30 may further include a third impurity layer 936 formed on the second waveguide layer, and a third electrode 937 formed on the third impurity layer, in case the type of the impurities doped in the first impurity layer and the second impurity layer is the same type. Also, in case the first impurity layer and the second impurity layer are the same n+-type impurity layer, the third impurity layer is a p+type impurity layer. In case the first impurity layer and the second impurity layer are the same p+-type impurity layer, the third impurity layer is the n+-type impurity layer.

The upper clad layer 913 and the lower clad layer 912 may be formed of silicon oxide. Also, the waveguide layer 914 may be formed of silicon semiconductor.

According to the optical device using semiconductors of a preferred embodiment of the present invention, optical refraction and reflection control can be achieved by means of semiconductor silicon which has a p-n junction structure and a waveguide structure. Also, according to the optical device using semiconductors of the present invention, the amplitude of light can be directly modulated using the reflection or refraction control.

1. An optical device comprising:
a first waveguide having an optical signal incident therein, formed in the same direction to the incident optical signal;
a second waveguide forming a preset angle from the first waveguide; and
a reflector having a refractive index variable based on an applied voltage to select a path of the optical signal to the first waveguide or the second waveguide, with forming an inclined angle with the first waveguide,
wherein the reflector comprises,
a first interface partially in contact with the first waveguide, with the optical signal incident therein; and
a second interface partially in contact with the first waveguide, with the optical signal transmit there through and
the reflector is a semiconductor element having a p-type or n-type impurity doped therein.

2. The optical device of claim 1, wherein the refractive index of the reflector is variable based on the voltage applied to a region of the reflector where a p-type impurity and an n-type impurity are doped, and
a p+-type impurity is further doped near the region where the p-type impurity is doped and a n+-type impurity is further doped near the region where and the n-type impurity is doped, to apply a voltage to the region where the p-type and n-type impurities are doped.

3. The optical device of claim 1, wherein the first interface of the reflector in contact with the first waveguide is formed by junction of an n-type impurity doped region and a p-type impurity doped region, and
the junction of the n-type and p-type impurity doped region is arranged in a longitudinal direction of the first waveguide.

4. The optical device of claim 1 or 2, wherein the first interface of the reflector in contact with the first waveguide is one type impurity doped region of the n-type or the p-type impurity doped region, and
the optical signal is incident in one type of the n-type or p-type impurity doped region.

5. The optical device of claim 1 or 2, wherein one of the first interface or second interface in contact with the first waveguide is a p-type impurity doped region, and
the other one of the first interface or the second interface is an n-type impurity doped region.

6. The optical device of claim 1, wherein the first interface of the reflector in contact with the first waveguide is a junction of the p-type impurity doped region and the n-type impurity doped region which is arranged vertically on a cross section of the reflector.

7. The optical device of claim 1, wherein the n-type impurity doped region is provided in a lower portion of the reflector and a n+-type impurity doped region is in contact with both ends of the n-type impurity doped region and the p-type impurity doped region is on the n-type impurity doped region and a p+-type impurity doped region is in contact on the top of the p-type impurity doped region, or
the p-type impurity doped region is provided in a lower portion of the reflector and a p+-type impurity doped region is in contact with both ends of the p-type impurity doped region and the n-type impurity doped region is provided on the p-type impurity doped region and a n+-type impurity doped region is in contact on the top of the n-type impurity doped region.

8. The optical device of claim 3, wherein the reflector has an intrinsic region provided between the n-type impurity doped region and the p-type impurity doped region, and
the optical signal is incident in the intrinsic region.

9. The optical device of claim 8, wherein the intrinsic region is provided in the first waveguide region provided in the reflector;
a first n-type impurity doped region and a second n-type impurity doped region are provided in both ends under the intrinsic region and a p+-type impurity doped region is provided on the tope of the intrinsic region; or
a first p-type impurity doped region and a second p-type impurity doped region are provided in both ends under the intrinsic region and a n+-type impurity doped region is provided on the top of the intrinsic region; and
the optical signal is incident in the intrinsic region of the reflector.

10. The optical device of claim 9, wherein a third n-type impurity doped region is provided between the first n-type impurity doped region and the second n-type impurity doped region, under the intrinsic region; or
a third p-type impurity doped region is provided between the first p-type impurity doped region and the second p-type impurity doped region, under the intrinsic region of the reflector.

11. The optical device of claim 1, wherein a line in contact with the n-type and p-type is diagonal, seen on top view of the reflector.

12. The optical device of claim 11, wherein the optical signal is incident from the p-type or n-type impurity doped region of the first interface and guided out to the first waveguide, using the n-type or p-type impurity doped region of the second interface, or to the second waveguide, using a depletion layer generated between the n-type impurity doped region and the p-type impurity doped region of the second interface.

13. The optical device of claim 1, wherein an intrinsic region is provided between the n-type impurity doped region and the p-type impurity doped region, seen in a cross section of a horizontal direction of the reflector, and
both sides of the intrinsic region are diagonal.

14. The optical device of claim 13, wherein the optical signal is incident from the n-type impurity doped region or the p-type impurity doped region of the first interface and guided out to the first waveguide, using the p-type impurity doped region or the n-type impurity doped region, or guided out to the second waveguide of the second interface, using the intrinsic region of the second interface.

15. The optical device of claim 1, wherein the reflector comprises,
a lower clad layer formed on a silicon substrate;
a waveguide layer formed on the lower clad layer;
a first impurity layer formed in one end of the waveguide layer;
a second impurity layer formed in the other end of the waveguide layer;
an upper clad layer formed on the waveguide layer;
a first electrode formed on the first impurity layer, passing through the upper clad layer; and
a second electrode formed on the second impurity layer, passing through the upper clad layer, and
each of the first impurity layer and the second impurity layer is a p+-type impurity layer or an n+-type impurity layer.

16. The optical device of claim 15, wherein a vertical cross section of the waveguide layer comprises,
a first waveguide layer having a horizontal side with a first length and a vertical side with a second length;
a second waveguide layer provided on the first waveguide layer, having a horizontal side with a third length and a vertical side with a fourth length, and
the first length is larger than the third length.

17. The optical device of claim 16, further comprising:
a third impurity layer formed on the second waveguide layer, in case the same type impurity is doped on the first impurity layer and the second impurity layer; and
a third electrode formed on the third impurity layer, passing through the clad layer,
wherein in case the first impurity layer and the second impurity layer are the same n+-type impurity, the third impurity layer is a p+-type impurity layer, and
in case the first impurity layer and the second impurity layer are the same p+-type impurity layer, the third impurity layer is a n+-type impurity layer.

18. The optical device of one of claims 15 through 17 claim 15, wherein the upper clad layer or the lower clad layer is formed of silicon oxide.

19. The optical device of claim 15, wherein the waveguide layer is formed of silicon semiconductor.
